(19) United States
(12) Patent Application Publication
(10) Pub. No.: US 2002/0046918 A1
(43) Pub. Date: Apr. 25, 2002

(54) Production system

(76) Inventors: Yasuhiko Yamazaki, Toyota-shi (JP); Masayuki Kitano, Toyota-shi (JP)

Correspondence Address: LAW OFFICE OF DAVID G POSZ, 2000 L STREET, N.W., SUITE 200, WASHINGTON, DC, 20036, US

(21) Appl. No.: 09/911,425

(22) Filed: Jul. 25, 2001

(30) Foreign Application Priority Data
Jul. 28, 2000 (JP) 2000-228882

(51) Int. Cl. B23Q 5/22

(52) U.S. Cl. 198/339.1

(57) ABSTRACT

All equipments for successive various processes for works are divided into a plurality of blocks to form production lines in which equipments in each production line are coupled with conveyers. These production lines are coupled to an automatic depot with a carriage system. This keeps the rate of operation of production lines high, so that useless increase in cost for equipments can be prevented. Moreover, this production system allows a production line or an equipment to be easily added in accordance with variation in the production rate or the type of products.

### BACKGROUND OF THE INVENTION

1. Field of the Invention

This invention relates to a production system including a plurality of blocks for mixedly producing a plurality of types of works.

2. Description of the Prior Art

A production system including automatic production lines for producing works is known. This production system is designed in accordance with the fixed production rate (the number of products at a production unit interval). In this system, if the fixed production rate is changed, a lack or an excess of power will occur.

For the production system having a variable production rate, a flexible transfer line (FTL) system is provided.

In this FTL system, if it is required to increase the production rate, equipments are added to shorten the production cyclic interval. This system is provided with assumption that each of equipment has a common function. That is, to transfer the function from one equipment to another to change the assignment of the process, it is required that the receiving and transferring sides should have the common function. Accordingly, a general type of equipments are used in such a system. If a production system is formed with the general type of equipments, the cost and useless functions will increase, and thus, the efficiency will decrease.

### SUMMARY OF THE INVENTION

The aim of the present invention is to provide a superior production system.

According to the present invention, a first aspect of the present invention provides a production system for mixedly producing a plurality of types of works comprising: a plurality of blocks as production lines, each block including a plurality of equipments and a conveyer for successively coupling a plurality of said equipments to convey said works, each of said equipments effecting a partial process to said works; a carrier for carrying said works between said blocks; and a buffer connected to said carrier for temporally storing said works.

According to the present invention, a second aspect of the present invention provides a production system based on the first aspect, wherein each of said blocks selectively effects a different process in accordance with one of said types of each of said works to mixedly produce a plurality of types of said works.

According to the present invention, a third aspect of the present invention provides a production system based on the first aspect, wherein each of said equipments has an average production cyclic interval and a dispersion in said production cyclic interval among a plurality of types of said works, and a range of successive equipments forming one of said blocks is determined in accordance with difference in said average production cyclic intervals and dispersion between each pair of equipments having consecutive relation with each other.

According to the present invention, a fourth aspect of the present invention provides a production system based on the first aspect, wherein a total cost of said production system includes a first cost of said carrier increasing with the number of said blocks and a second cost of useless capacity in said equipments caused by difference in production cyclic intervals among equipments in said block, said second cost decreasing with the number of said blocks, and the number of said blocks is determined by the minimum of said total cost.

According to the present invention, a fifth aspect of the present invention provides a production system based on the first aspect, wherein each of said block further includes inputting and outputting means at one end thereof for inputting and outputting works, and said conveyer includes a supplying conveyer for supplying said works inputted by said inputting and outputting means at one end thereof from one of said equipments to the next equipment in said block and a returning conveyer for returning said works from the last of said equipments in said block to said carrier through said inputting and outputting means.

According to the present invention, a sixth aspect of the present invention provides a production system based on the fifth aspect, wherein said carrier comprises a carriage for moving around a predetermined loop which is arranged near said inputting and outputting means of said blocks, and said input and outputting means transfers said works between said carriage and one of said equipments nearest said input and outputting means in each of said blocks.

According to the present invention, a seventh aspect of the present invention provides a production system based on the first aspect, wherein the number of said equipments in one of said blocks is changed when a requested number of said works is changed.

According to the present invention, an eighth aspect of the present invention provides a production system based on the first aspect, wherein said equipments are added to one of said blocks, when a new type of said works requiring a new process is produced in said production system, and said added equipments effects said new process.

According to the present invention, a ninth aspect of the present invention provides a production system based on the first aspect, wherein each of said equipments has an average production cyclic interval and a dispersion in said production cyclic interval among a plurality of types of said works, each pair of neighboring consecutive equipments is successively connected as said production line in order of difference in said average production cyclic interval therebetween until the lowest cost of said production system is determined.

According to the present invention, a tenth aspect of the present invention provides a production system based on the ninth aspect, wherein each pair of neighboring consecutive equipments is not connected when difference in dispersion therebetween is greater than a reference.

According to the present invention, an eleventh aspect of the present invention provides a production system based on the tenth aspect, wherein a not-connected equipment is coupled to said buffer through said carryings means.

### BRIEF DESCRIPTION OF THE DRAWINGS

The object and features of the present invention will become more readily apparent from the following detailed description taken in conjunction with the accompanying drawings in which:

FIG. 1 is a perspective view of a production system according to an embodiment of the present invention;

FIG. 2 is a perspective view of the equipment shown in FIG. 1;

FIG. 3 is a perspective view of a part of the production line according to the embodiment;

FIG. 4 is an illustration of this embodiment showing block dividing operation;

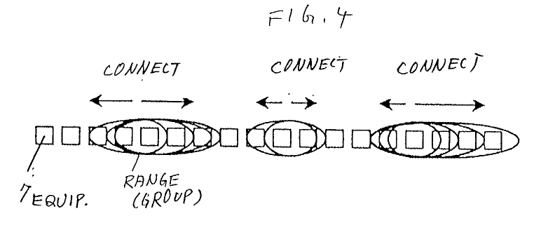

FIG. 5 is a graphical drawing regarding the block dividing operation according to this embodiment;

FIG. 6 is an illustration showing production changing operation according to this embodiment;

FIG. 7 is a graphical drawing showing variations in repayment ratio of this invention and a prior art; and

FIG. 8 depicts a flow chart showing the block dividing operation in another modification of this invention.

The same or corresponding elements or parts are designated with like references throughout the drawings.

### DETAILED DESCRIPTION OF THE INVENTION

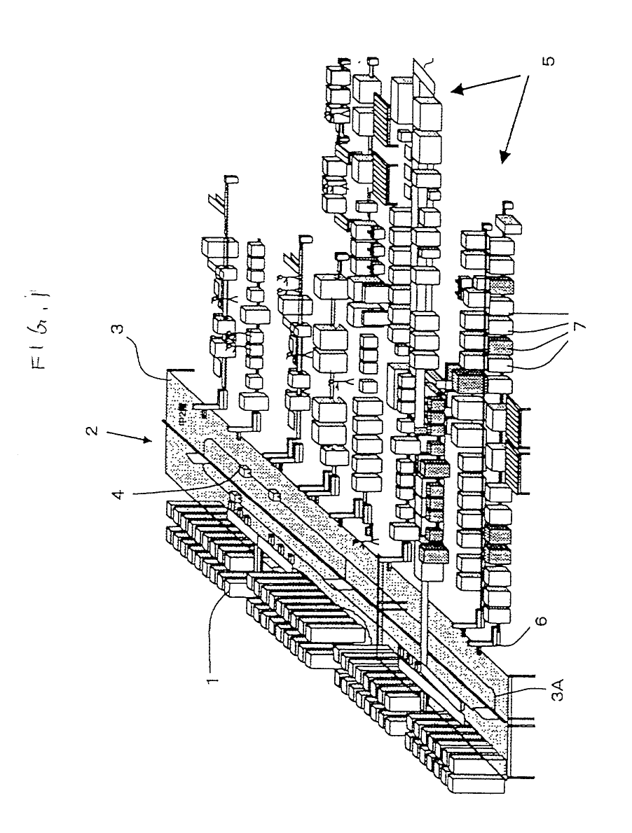

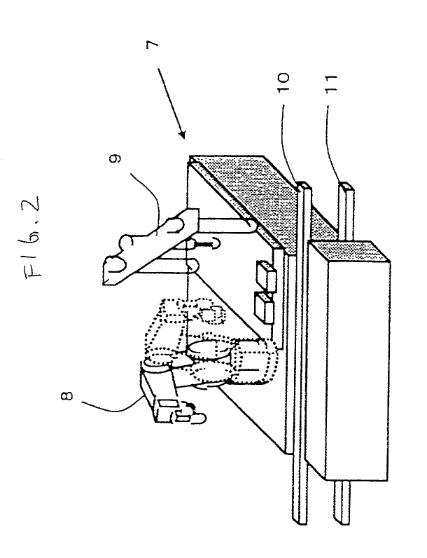

FIG. 1 is a perspective view of a production system according to an embodiment of the present invention and FIG. 2 is a perspective view of the equipment shown in FIG. 1.

The production system mixedly produces a plurality of types of works and includes a plurality of blocks. Each block includes a production line 5 which includes a plurality of equipments 7. Each equipment 7 effects a partial process to the works. The production line 5 further includes a conveyer 10 for successively coupling a plurality of the equipments 7 in the production line 5 to convey the works. The production system further includes an automatic depot 1 as a buffer for production lines 5 by temporarily storing the works from the production lines 5, and a carriage system 2 including carriages 4 and rail 3A for carrying the works between the production lines 5 and between the production lines 5 and the automatic depot 1.

In this production system, all equipments 7 are divided into a plurality of blocks. In each block, the general type of equipments 7 are employed. For example, it is assumed that this production system produces ABS (Antilock Brake System) actuators. The production process of the ABS actuators includes processes of mounting various types of solenoid valves on a housing, mounting a motor and a pump, and sealing with a cover. Respective processes include caulking, press fitting, assembling, screw fastening, welding, inspecting or the like. These various processes are divided into a plurality of blocks along the successive flow. In each block, equipments 7 are connected to provide each production line 5.

These production lines 5 are coupled to the carrying system 2 through lifts 6, each having inputting and outputting function of the work between the automatic depot 1 and the production line 5. The top of equipment 7 in each production line 5 has a function for transferring works to and from the lift 6. More specifically, the top equipment 7 receives a container including works, successively takes out each work in the container, and puts on a pallet on the supplying conveyer 10 of the production line 5. When the process of the last equipment 7 of the production line 5 has finished, the work on the pallet is returned to the top equipment 7 of the production line 5 with a return conveyer 11. When the work is returned to the top equipment 7, the top equipment 7 takes the work from the pallet and puts the work in the container. When the necessary number of works are put in the container, the top equipment 7 sends the container to the carriage system 2 through the lift 6.

The carriage system 2 includes a rack 3 arranged on a second floor (a mezzanine floor), a loop rail 3A on the rack 3, and carriages 4 on the rail 3A. The rack 3 supports the rail 3A. The carriage revolves on the loop rail 3A and receives the container from the lift 6 to supply the container directly to another production line 5 or through temporarily storing by the automatic depot 1. The carriages 4 revolve on the rail 3A on the rack to effectively utilize the area and to provide free movement of operators and works on the first floor.

If there is a process having difficulty in automating for production process of the works, equipments for the process will be independently provided from the production lines 5. Hence, the automatic depot 1 has an inlet/outlet at the first floor. The independent equipments are coupled to the automatic depot 1 with automatic vehicle.

Each production line 5 has a plurality of equipments 7 for effecting various processes. In FIG. 2, the equipment 7 includes a general use robot 8 and a working unit 9. The general use robot 8 chucks a work conveyed by the supply conveyer 10. The working unit 9 effects caulking, press fitting, assembling, screw fastening, welding, inspecting or the like. In this embodiment, a common standard for chucking is provided to all types of works to enable the general use robot 8 to chuck all types of works having different sizes. Almost all of equipments 7 have the general use robots 8 having a common chuck to provide a higher degree of freedom in various types of products.

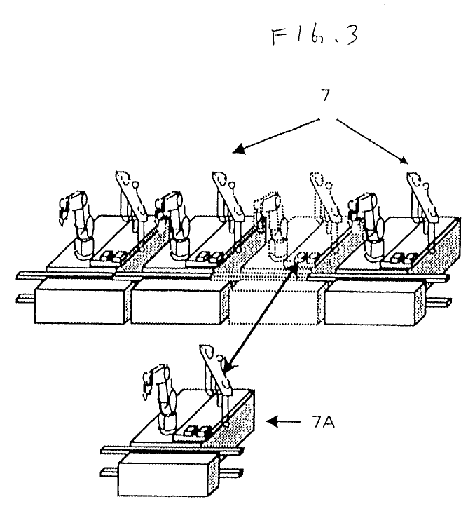

To readily increase a production power or add a new function, the production system is required to add or change the equipments 7 freely. For this, each equipment 7 has a common size, and the conveyers 10 and 11 have a common specification. Therefore, a new equipment 7A can be readily added to a production line 5 as shown in FIG. 3. To freely add, remove, or change the equipment 7, each equipment 7 is of a stand alone type regarding hardware and software to prevent interference with other equipments for different process. Moreover, only replacing the working unit 9 with another one provides adding or changing a function because the general use robot 8 has the common chuck.

A controlling method of producing works will be described.

Each container containing works has a reference tag which is data-writable and data-readable. The reference tag stores data for the works in the container. Based on the data, the production line 5 receiving the container and the process to be done are determined for each container. When the processes to be done by the equipments in the production line 5 have finished, this fact is written in the reference tag. Next, the control equipment (not shown) for controlling the production system commands the next production line 5 and the timing of inputting the container in the next production line 5. When all processes for the works in a container have finished, the container is outputted from this production system.

The equipments 7 for effecting a successive processes for the works are divided into a plurality of groups (blocks). This method will be described.

If there is difference in production cyclic interval in processing in each equipment 7, and if equipments 7 are coupled to each other, the production power is dependent on the lowest precaution cyclic interval thereof. Accordingly, the equipments having a shorter production cyclic interval will have a useless excess power, so that a loss will occur. To reduce the loss, each equipment may be independently used without coupling the equipments. On the other hand, if there is no coupling between equipments 7, a greater cost for conveying works between equipments 7 (production lines 5) will occur. Accordingly, there is a relation that a cost for a useless excess power of equipments 7 increases with the number of coupled equipments 7, and another relation that a cost for carrying works with the lift 6 and the carriage 4 increases with the number of divided blocks. Hence, the dividing the equipments 7 into blocks, or coupling equipments in a production line, is determined by the minimum of sum of these costs.

More specifically, uselessness in production power in the case of coupling equipments becomes an excess power in the production equipments and can be converted directly into a cost with an equation of (1-equipment load ratio)×equipment cost. This is assumed as an increase in the cost of equipment, and the optimal value is determined through comparison with the cost of conveying in the case that the equipments are not coupled. Preferably, the optimal value is obtained as follows:

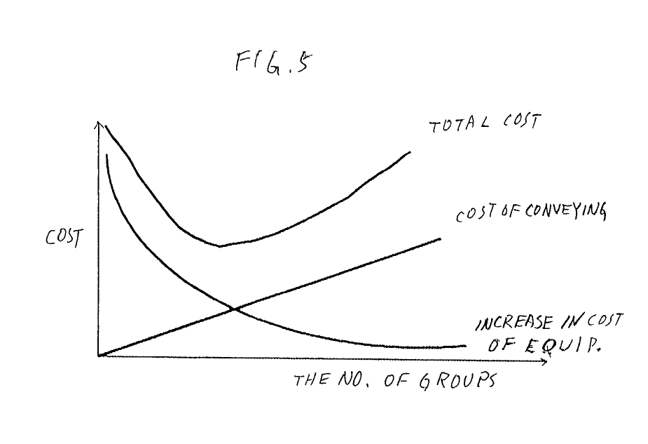

At first, the cost is calculated in the condition that all equipments are divided (coupled with the automatic depot 1). Next, the neighbor equipments along the flow of process are connected to each other with conveyers 10 and 11, which show substantially the same (near) average cyclic intervals and substantially the same dispersion. In this condition, the increase in cost due to coupling is calculated. Moreover, the cost of conveying works between equipments is calculated every when the coupling condition of equipments is changed. In this way, the range of coupling equipments is expanded. In each condition, the increase in cost of the equipments and the costs of conveying (carrying) works is calculated. FIG. 5 is a graphical drawing showing the calculation result.

Generally, as shown in FIG. 5, with decrease in the number of groups (blocks) by coupling equipments, a rate of increase in the cost of equipments gradually increases. Next, it rapidly increases exponentially.

On the other hand, the cost of conveying will decrease with decrease in the number of groups (blocks). Therefore, there is a point giving the lowest total cost of the costs of equipment and conveying works. This condition is the optimal condition of the whole of the production system.

Moreover, this calculation is repeated every when the number of products varies or the type of products is changed. Next, the maximum divisor like condition can be selected. Moreover, if the grouping is selected with weighting in accordance with degree of occurrences of the above-mentioned variation, a production system showing a higher working efficiency in equipments is provided even though the above-mentioned variation occurs.

In this production system, all equipments for effecting successive process are divided into a plurality of production lines 5, and the conveyers 10 and 11 and the sizes of each equipments 7 are made common, so addition and removing equipments in each production line 5 can be readily performed. For this reason, there is no necessity for largely changing the whole layout like the prior art TR (transfer) line in which equipments are successively connected. Accordingly, this production system can be modified in accordance with increase or decrease in the number of products.

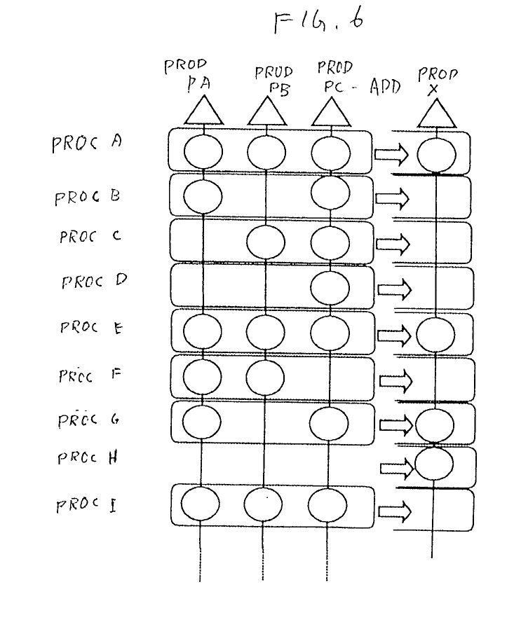

Moreover, as shown in FIG. 6, if a new product X is added to the products A, B, and C, this production system can readily meet the request. In FIG. 6, groups of processes, which are a part or the whole of each line 5, are represented with processes A, B, and C for convenience.

If an additional product X is provided with processes A, E, G, and H, a present line 5 for products PA, PB, and PC including processes A to B and I is used. In this case, if the loads to the production line 5 for the processes A, E, and G become too large, it is sufficient to add the equipment 7 having the same function or to replace the working unit 9 with one having a higher performance.

On the other hand, the process H which is specially provided for the added product X is add by inserting an equipment 7 for the process H to the production line 5 or adding a new production line 5 including equipments 7 effecting the process H.

In the production system according to the embodiment, the carriage system 2 provides coupling between the production lines 5 and between the production lines 5 and the automatic depot 1. Hence, if this structure is compared with the structure in the case that all equipments were connected in series, though the production rate of works is relatively low, it is clear that the power of respective equipments 7 can be fully utilized, so that increase in the cost of equipment can be suppressed.

Then, in the production system according to this embodiment, if a low number of works is inputted into a production line 5 having a long cyclic interval, the works are inputted into the production line 5 through temporarily storing in the automatic depot 1. This allows the previous production lines for previous process for the work to operate at its original cyclic interval, so that the rates of operation of equipments 7 in each production line 5 can be kept high.

Comparison of ability against variation in the rate of products (the number of products) including variation in types of the production system according to this embodiment with that of the prior art TR line is as follows:

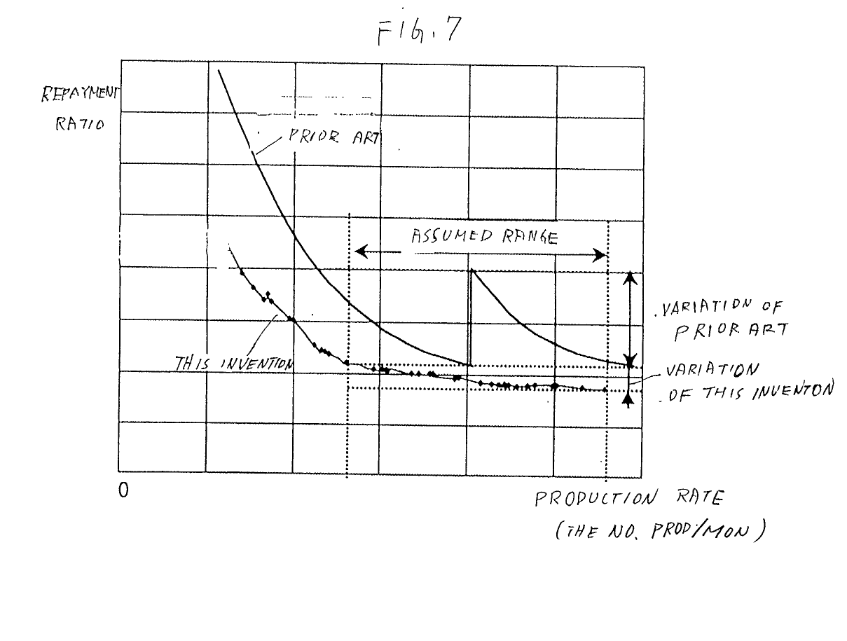

Tracing variation in the production trend corresponds dealing the equipment repayment, which is originally independent on the production rate but is a constant cost, as equipment repayment varying with the production rate. FIG. 7 is a graphical drawing showing repayment ratios to the sales of the production line according to this embodiment and that of the prior art TR line.

As shown in FIG. 7, the repayment ratio of the prior art TR line varies with variation of the number of products (production rate) as a curve of secondary degree. On the other hand, this production system according to this embodiment remains at a substantially constant level within the assumed range. More specifically, the variation of the repayment ratio of the production system according to this embodiment is one-tenth times that of the prior art TR line. This proves that this production system shows a high power for variation in the rate of products.

The favorable embodiment has been described above. However, this invention is not limited to the above-mentioned embodiment and provides various modifications.

For example, the automatic depot 1 is used as a buffer for temporarily storing works. However, any other buffer can be used such as pallets or racks.

Moreover, the carriage 4 on the rail is described as the carriage system 2. However, any other carriage system can be used. For example, automatically guided vehicles or conveyers can couple between production lines 5 or production line 5 and the buffer. Moreover, when the automatic depot 1 is used as the buffer, the carriage system 2 can be omitted. That is, the production lines 5 are directly connected to the automatic depot 1.

In the above-mentioned embodiment, dividing is effected with a unit of the equipments 7. However, dividing may be executed with a unit of processes (at least an equipment). For example, if different types of products PA, PB, and PC are processed as shown in FIG. 6, the processes are different from each other. Therefore, there may be a difference of the number of works to be processed between respective processes. If it is assumed that the equipments 7 for the process B (effected by at least one equipment 7) have a lower power than the equipments 7 for process A, that is, if the equipments 7 for the process B have a long cyclic interval, this equipments has no useless power (capacity). This condition can suppress increase in the cost of equipment.

On the other hand, if the equipments 7 for the process A were not separated from the equipments for the process B, it is necessary to equalize the production power for the process B with that for the process A, so that the equipments for the process B will have a useless production power (capacity).

Another modification will be described.

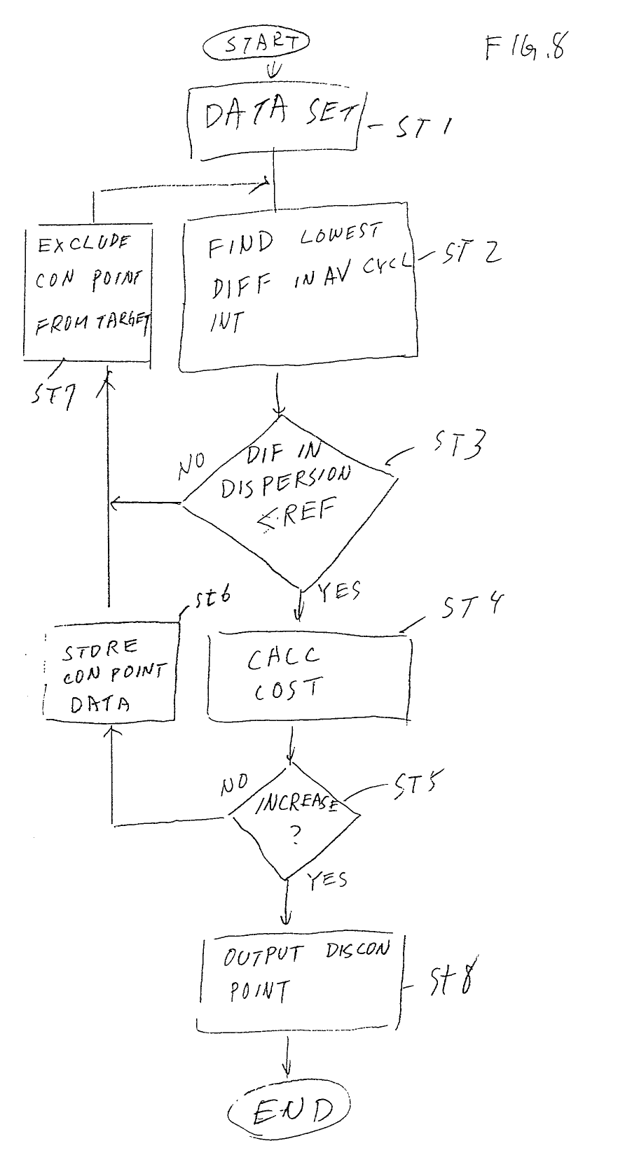

FIG. 8 depicts a flow chart showing the block dividing operation in another modification. This operation may be effected manually or with a program for a computer.

All equipments are divided into a plurality of blocks as production line 5 as follows:

At first, it is assumed that all equipments 7 in this production system are successively arranged in series in order of processing (along the flow of processes). The average production cyclic intervals and dispersions in the production cyclic interval are calculated and stored for each of equipments 7 in step st1. Next, the lowest difference in average production cyclic interval between each pair of consecutive equipments is found in step st2. If the difference in desperation in the production cyclic interval between the equipments of which difference in average production cyclic interval is the lowest is lower than a reference in step st3, processing proceeds to step st4. In step st4, a cost of the production system is calculated. In step st5, if the cost does not increases from the previous calculation result, processing proceeds to step st6. In step st6, the connection point data indicating the pair of the equipments showing the lowest difference in the average production cyclic interval is stored. Next, the connection point is excluded from the target in the step st7. Next, processing returns to step st2. In step st2, the lowest difference in average production cyclic interval between each pair of consecutive terminals within the target is found in step st2. That is, the second lowest difference in average production cyclic interval between each pair of consecutive equipments is found. This operation is repeated until the cost increases from the provirus calculation result. If the cost increases from the previous calculation result in step st5, the just pervious cost is the minimum cost as shown in FIG. 5. Next, the disconnection point obtained from the connection point data are outputted. At the disconnection point, the production line 5 is coupled to the automatic depot l.

As mentioned above, each equipment is connected in order of difference in the average cyclic interval between consecutive equipments 7. However, if difference in dispersion therebetween is large, these equipments are not connected. This operation is repeated, and if the cost increases, the previous condition provides the minimum cost.

What is claimed is:

1. A production system for mixedly producing a plurality of types of works comprising:
a plurality of blocks as production lines, each block including a plurality of equipments and a conveyer for successively coupling a plurality of said equipments to convey said works, each of said equipments effecting a partial process to said works;
a carrier for carrying said works between said blocks; and
a buffer connected to said carrier for temporally storing said works.

2. A production system as claimed in claim 1, wherein each of said blocks selectively effects a different process in accordance with one of said types of each of said works to mixedly produce a plurality of types of said works.

3. A production system as claimed in claim 1, wherein each of said equipments has an average production cyclic interval and a dispersion in said production cyclic interval among a plurality of types of said works, and a range of successive equipments forming one of said blocks is determined in accordance with difference in said average production cyclic intervals and dispersion between each pair of equipments having consecutive relation with each other.

4. A production system as claimed in claim 1, wherein a total cost of said production system includes a first cost of said carrier increasing with the number of said blocks and a second cost of useless capacity in said equipments caused by difference in production cyclic intervals among equipments in said block, said second cost decreasing with the number of said blocks, and the number of said blocks is determined by the minimum of said total cost.

5. A production system as claimed in claim 1, wherein each of said block further includes inputting and outputting means at one end thereof for inputting and outputting works, and said conveyer includes a supplying conveyer for supplying said works inputted by said inputting and outputting means at one end thereof from one of said equipments to the next equipment in said block and a returning conveyer for returning said works from the last of said equipments in said block to said carrier through said inputting and outputting means.

6. A production system as claimed in claim 5, wherein said carrier comprises a carriage for moving around a predetermined loop which is arranged near said inputting and outputting means of said blocks, and said input and outputting means transfers said works between said carriage and one of said equipments nearest said input and outputting means in each of said blocks.

7. A production system as claimed in claim 1, wherein the number of said equipments in one of said blocks is changed when a requested number of said works is changed.

8. A production system as claimed in claim 1, wherein said equipments are added to one of said blocks, when a new type of said works requiring a new process is produced in said production system, and said added equipments effects said new process.

9. A production system as claimed in claim 1, wherein each of said equipments has an average production cyclic interval and a dispersion in said production cyclic interval among a plurality of types of said works, each pair of neighboring consecutive equipments is successively connected as said production line in order of difference in said average production cyclic interval therebetween until the lowest cost of said production system is determined.

10. A production system as claimed in claim 9, wherein each pair of neighboring consecutive equipments is not connected when difference in dispersion therebetween is greater than a reference.

11. A production system as claimed in claim 10, wherein a not-connected equipment is coupled to said buffer through said carryings means.
